(19) United States
(12) Patent Application Publication
(10) Pub. No.: US 2012/0162232 A1
(43) Pub. Date: Jun. 28, 2012

(54) METHOD OF FABRICATION AND RESULTANT ENCAPSULATED ELECTROMECHANICAL DEVICE

(75) Inventors: RIHUI HE, San Jose, CA (US); Xiaoming Yan, Sunnyvale, CA (US); Je-Hsiung Lan, Cupertino, CA (US)

(73) Assignee: QUALCOMM MEMS Technologies, Inc., San Diego, CA (US)

(21) Appl. No.: 12/976,647

(22) Filed: Dec. 22, 2010

(51) Int. Cl. G06T 1/00; G02B 26/00

(52) U.S. Cl. 345/501; 359/291

(57) ABSTRACT

This disclosure provides systems, methods, and apparatus for encapsulated electromechanical systems. In one aspect, a release path includes a release hole through an encapsulation layer. The release path exposes a portion of a first sacrificial layer that extends beyond a second sacrificial layer in a horizontal direction. This allows the first sacrificial layer and the second sacrificial layer to later be etched through the release path. The corresponding electromechanical system device includes a shell layer encapsulating a mechanical layer. A conformal layer seals a release hole that extends through a shell layer. A portion of the conformal layer blocks the opening of the release passage within the release hole. The release passage has substantially the same vertical height as a gap that defines the spacing between the mechanical layer and a substrate.

### TECHNICAL FIELD

This disclosure relates to electromechanical systems devices and methods for fabricating the same.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Some electromechanical systems devices include a layer that protects a mechanical element. For example, a mechanical element can be protected by a layer that may be referred to as an “encapsulation layer” or a “shell layer” over the electromechanical systems device. Encapsulation can protect electromechanical devices from environmental hazards, such as moisture and mechanical shock.

### SUMMARY

The systems, methods, and devices of the present disclosure each have several innovative aspects, no single one of which is solely responsible for the desirable attributes disclosed herein.

One innovative aspect of the subject matter described in this disclosure can be implemented in an apparatus that includes an electromechanical systems device. The electromechanical systems device includes a substrate and a mechanical layer spaced from the substrate by a gap. The electromechanical systems device also includes a shell layer encapsulating the mechanical layer. The shell layer includes a release hole therethrough. A release passage has an opening at the release hole. The release passage also has substantially the same vertical height as the gap. In addition, a conformal layer sealing the release hole in the shell layer is provided. At least a portion of the conformal sealing layer blocks the opening of the release passage within the release hole.

The release passage can have a horizontal length that is at least five times the vertical height of the gap, and can be substantially parallel to a major surface of the substrate. Alternatively or additionally, the conformal sealing layer can be thicker than the vertical height of the release passage. In some instances, the shell layer can define a ceiling of the release passage. The electromechanical systems device can include an interferometric modulator.

Another innovative aspect of the subject matter described in this disclosure can be implemented in an apparatus including an electromechanical systems device. The electromechanical systems device includes a substrate. A post layer is formed over the substrate and provides structural support. The electromechanical systems device also includes a mechanical layer spaced from the substrate by a gap. A shell layer encapsulates the mechanical layer. In addition, the electromechanical systems device includes a sealing layer over the shell layer. The sealing layer is formed within a release hole etched though the shell layer and the post layer.

The electromechanical systems device also can include a release passage adjacent to at least a portion of the sealing layer at the same vertical position as at least a portion of the gap. In some instances, the release passage can be between the post layer and the substrate. At least a portion of the sealing layer can block an opening between the release passage and the release hole according to some instances. The post layer can enclose substantially an entire horizontal perimeter of the release hole. Horizontally adjacent to at least a portion of the sealing layer, the post layer can be spaced from the substrate at substantially the same vertical height as the gap.

Another innovative aspect of the subject matter described in this disclosure can be implemented in an apparatus including an electromechanical systems device. The electromechanical systems device includes means for supporting the electromechanical device, movable means for defining a collapsible gap, encapsulating means for encapsulating the movable means, access means for release etching through the encapsulating means at least a portion of sacrificial material below the movable means prior to release etching sacrificial material above the movable means, and sealing means for sealing the access means.

The electromechanical systems device can include an interferometric modulator. The access means can include a release hole through the encapsulating means and a release passage having substantially the same vertical height and vertical position as the collapsible gap. The sealing means can include a conformal layer that blocks an opening of the release passage within the release hole. The movable means can include a mechanical layer. The means for supporting can include a substantially transparent substrate. The encapsulating means can include a conformal shell layer spaced above the movable means.

Another innovative aspect of the subject matter described in this disclosure can be implemented in a method of forming an electromechanical systems device. The method includes providing a stationary lower electrode and depositing a first sacrificial layer over the stationary lower electrode. The first sacrificial layer defines a separation gap between the stationary lower electrode and a mechanical layer. The method also includes forming the mechanical layer over the first sacrificial layer, depositing a second sacrificial layer over the mechanical layer, depositing an encapsulation layer over the second sacrificial layer, and providing a release path including a release hole through the encapsulation layer. The release path exposes a portion of the first sacrificial layer.

The release hole can expose a portion of the first sacrificial layer. The first sacrificial layer can be wider than the second sacrificial layer in a direction substantially parallel to the stationary lower electrode. The electromechanical systems device can be an interferometric modulator.

The method also can include etching at least a portion of the first sacrificial layer before etching any of the second sacrificial layer(s). Alternatively or additionally, the method can include extending the release path by removing at least a portion of the first sacrificial layer between the substrate and the encapsulation layer. The method also can include forming a support layer over the stationary lower electrode and over at least a portion of the first sacrificial layer. In such a method, providing the release path can include extending a release hole through the support layer. In some instances, the method can include removing at least a portion of the first sacrificial layer before removing any of the second sacrificial layer(s), thereby creating a release passage between the support layer and the substrate. The first and second sacrificial layers can be etched through the release hole.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A through 9J show examples of schematic cross-sections illustrating manufacturing processes for encapsulated electromechanical devices according to one implementation.

FIGS. 10A through 10I show examples of schematic cross-sections illustrating manufacturing processes for encapsulated electromechanical devices according to another implementation.

FIG. 11 shows an example of a flow diagram illustrating a process of forming an encapsulated electromechanical systems device.

FIG. 12 illustrates an example top view of release holes in an interferometric modulator (IMOD) array.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

A process for forming an encapsulated electromechanical device structure is disclosed, along with corresponding electromechanical devices. In one implementation, the electromechanical device structure can be formed by etching a release path that includes a narrow release passage defined by a first sacrificial layer that defines a gap between a substrate (or a stationary electrode) and a mechanical layer. The first sacrificial layer extends wider than a second sacrificial layer that is formed between the mechanical layer and an encapsulation layer. As the first sacrificial layer is etched away from a release hole near its periphery, a passage is formed for access of the etchant to both the rest of the first sacrificial layer and the second sacrificial layer to be released, and the resultant passage is readily sealed after release by a conformal sealing layer.

Particular implementations of the subject matter described in this disclosure can be implemented to realize one or more of the following potential advantages. The methods and structures described herein permit use of the same sacrificial layer(s) for both defining the operational gap for an electromechanical device or array and a release path for etchant to reach the sacrificial material between the mechanical layer and encapsulating material. Reducing the number of depositions, masks and/or etching steps and associated processing can save considerable time and cost.

One example of a suitable electromechanical systems device, e.g., a MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths, allowing for a color display in addition to black and white.

The IMOD display device can include a row/column array of IMODs. Each IMOD can include a pair of reflective layers, particularly a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16, which serves as or includes the stationary electrode for the illustrated IMOD implementation. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14 back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 microns (μm), while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

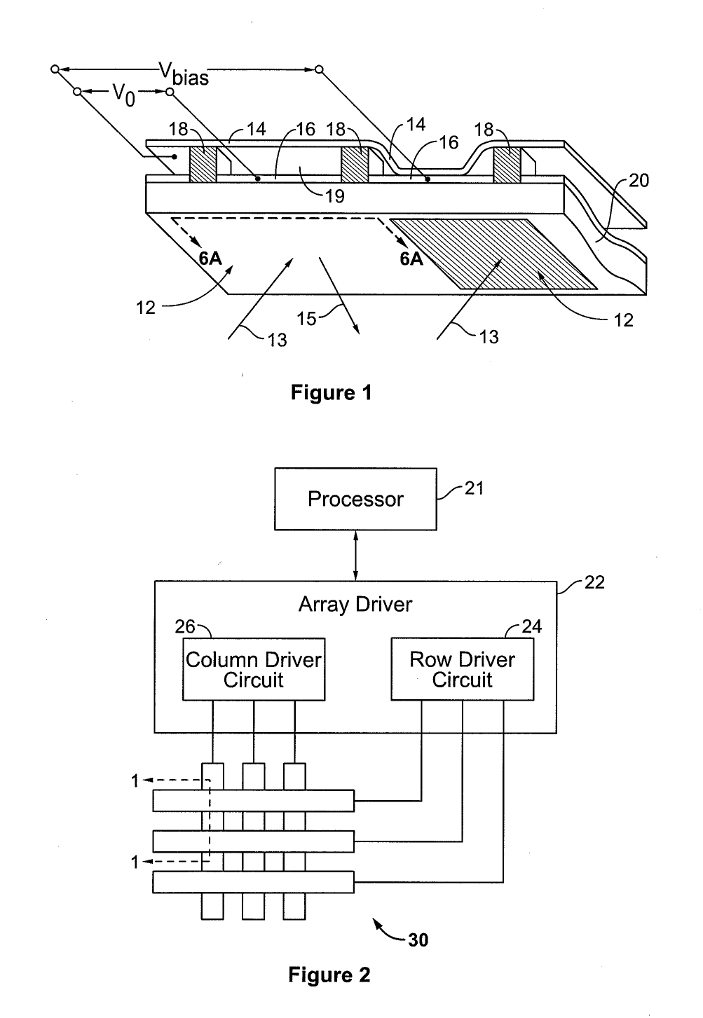

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

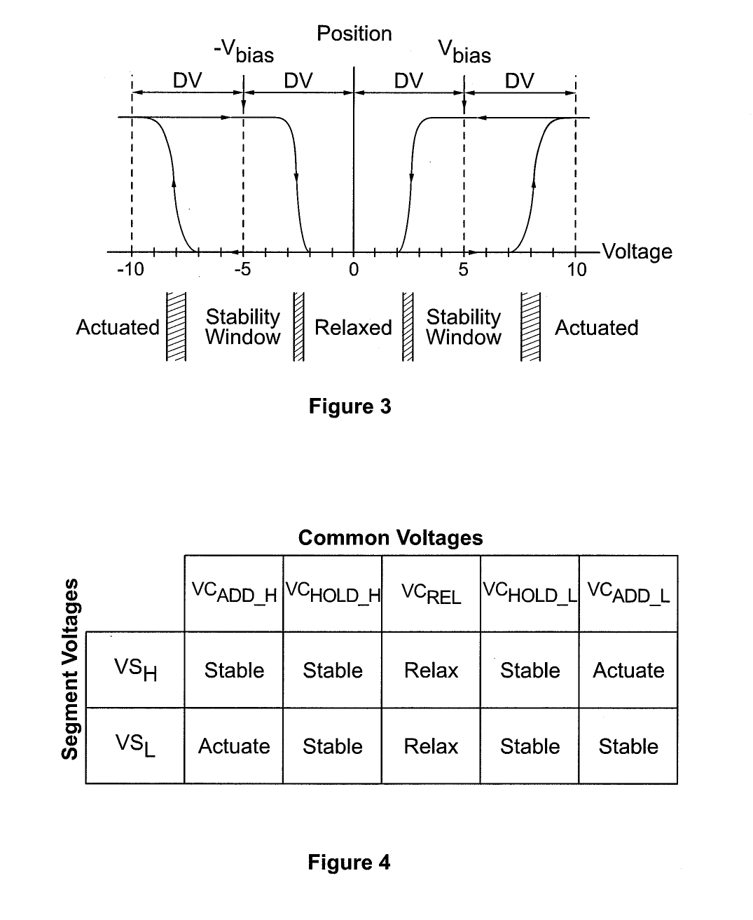

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

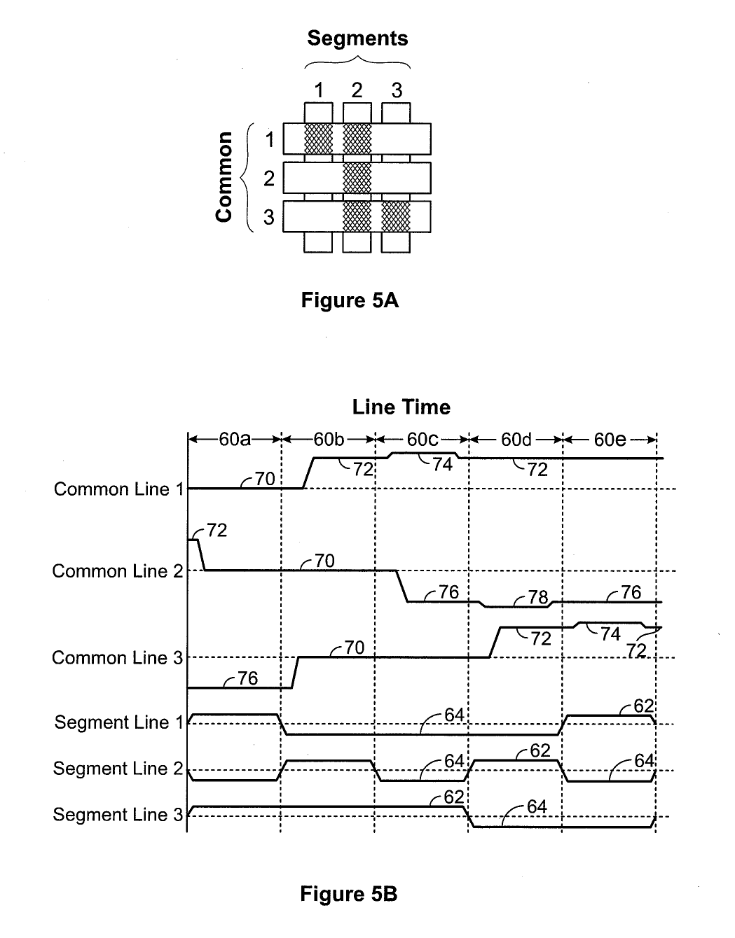

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written-to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (e.g., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

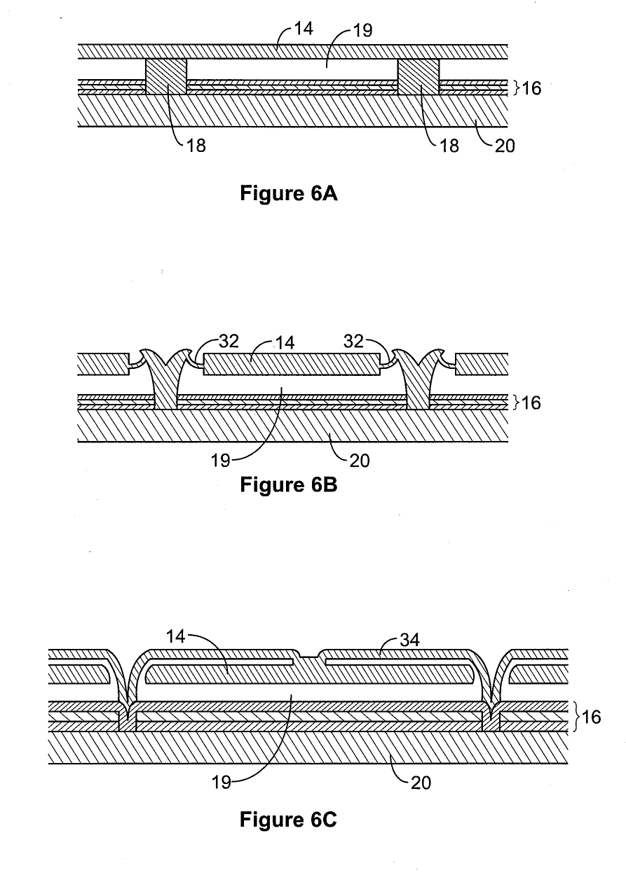

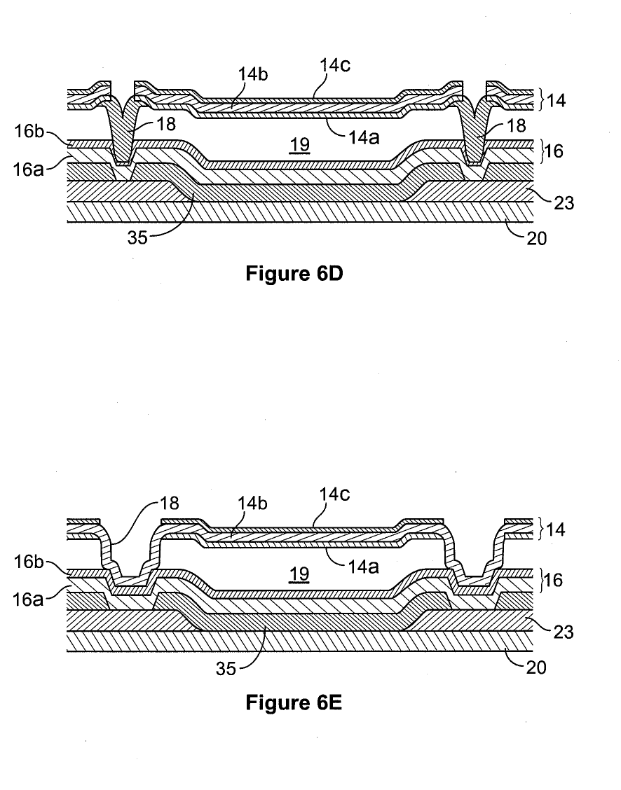

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (e.g., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can include conductor(s) and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with thicknesses in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include separate materials for support posts 18. Instead, at least a portion of the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14, which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

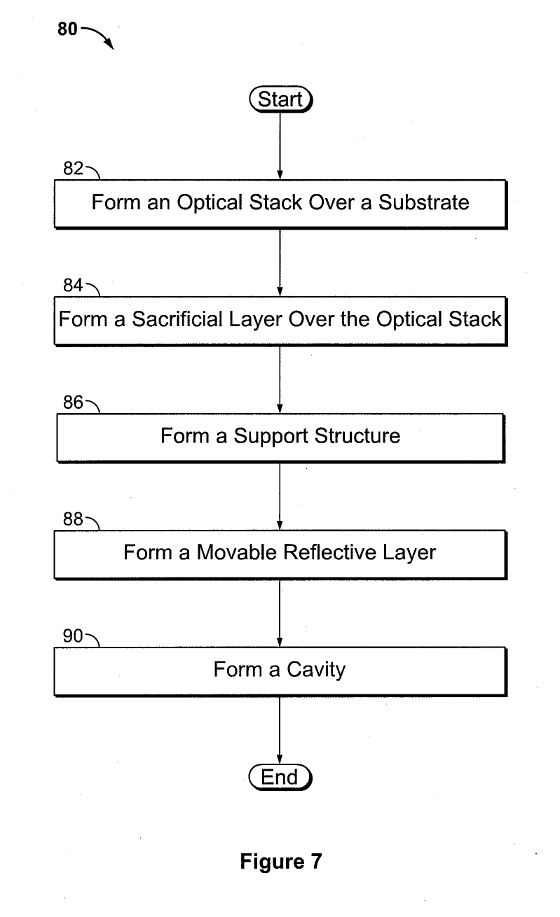

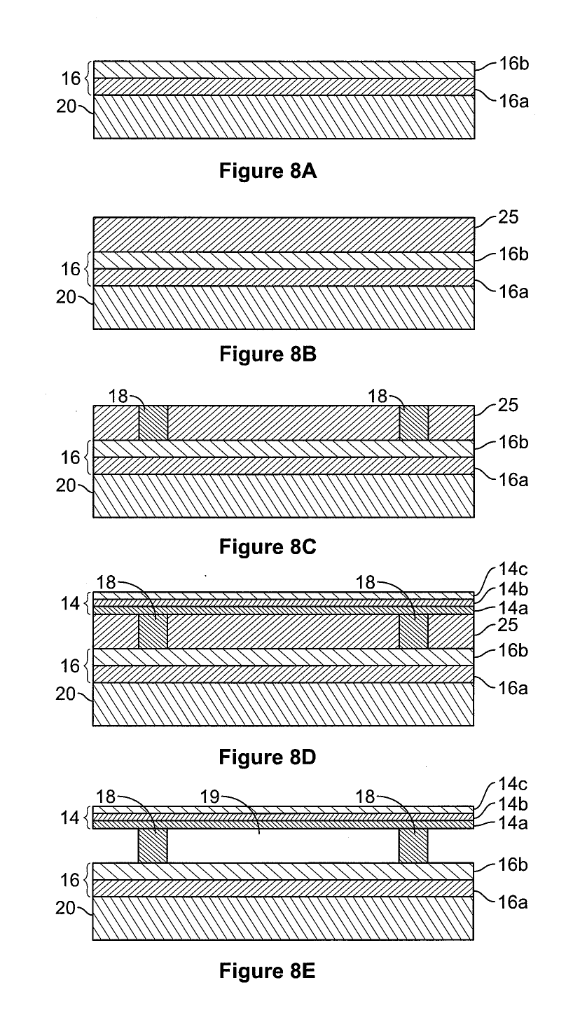

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6A-6E, in addition to other blocks not shown in FIG. 7. With reference to FIGS. 1, 6A-6E and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 (FIG. 8E) and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a fluorine-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6A-6E and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. In other arrangements, the support posts can land on a black mask structure. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by masking and etching processes, but also may be performed by alternative patterning methods.

The process 80 continues at block 88 with the formation of a movable reflective layer or membrane such as the movable reflective layer 14 illustrated in FIGS. 1, 6A-6E and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Electromechanical devices, such as those shown in FIGS. 6A-6E, can be encapsulated. Encapsulation can protect electromechanical devices from environmental hazards, such as moisture and mechanical shock. In some implementations, the encapsulation layer can function as a substrate for additional circuit elements formed above the encapsulation layer. Electromechanical devices can be encapsulated using thin films. Encapsulation is applicable to both individual devices and arrays of electromechanical devices, such as the display arrays illustrated and described above.

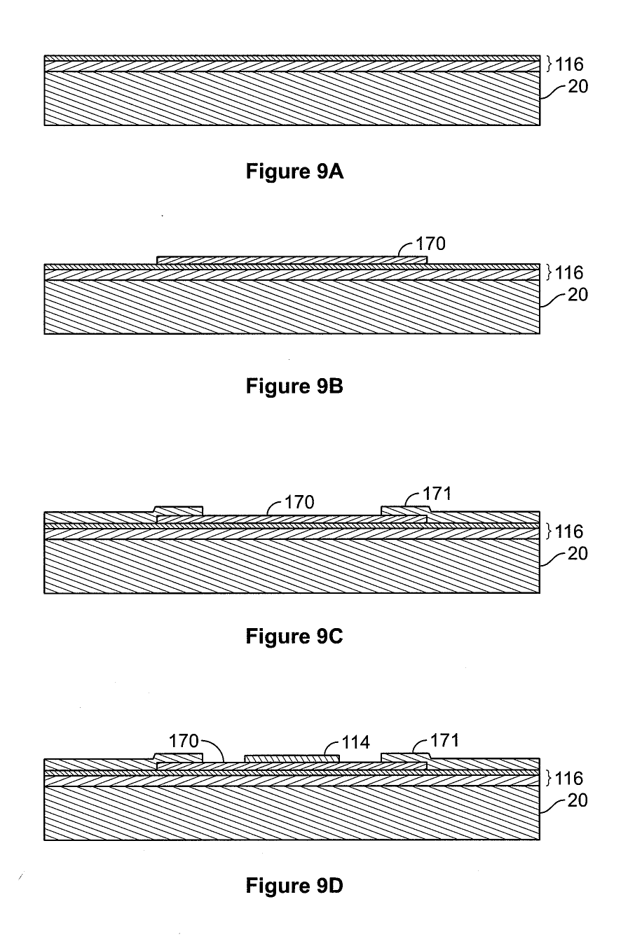

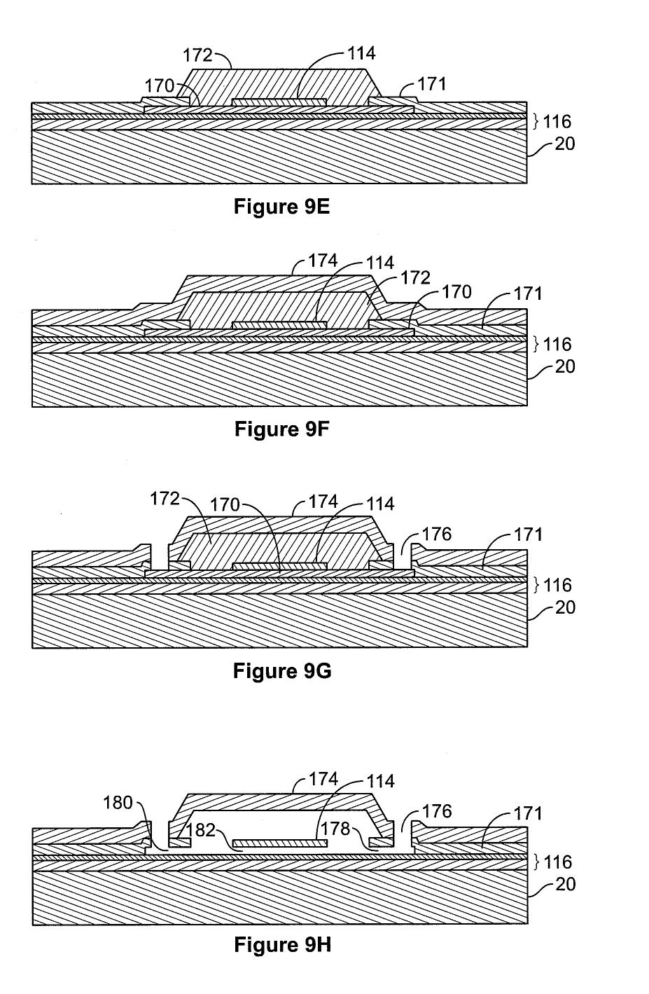

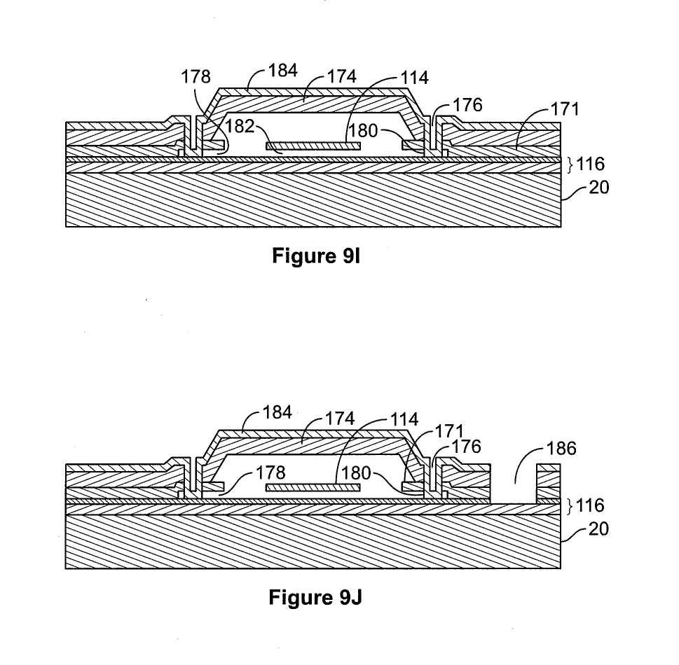

There is a need for using a reduced number of masks and processes to release sacrificial material formed under an encapsulation layer. Depositing each material while forming an encapsulated electromechanical structure can require a separate mask and a separate process. Reducing the number of masks required and processes can save considerable time and cost. The following processes described in connection with FIGS. 9A-9J, 10A-10I, and 11 can simplify existing thin film encapsulation methods, use fewer masks and produce simpler structures, as a separate mask is not needed to produce a sealable release path.

FIGS. 9A through 9J show examples of schematic cross-sections illustrating manufacturing processes for encapsulated electromechanical devices according to one implementation. While particular structures and processes are described as suitable for an interferometric modulator (IMOD) implementation, it will be understood that for other electromechanical systems implementations (e.g., electromechanical switches, optical filters, accelerometers, etc.), different materials can be used or parts modified, omitted, or added. Additionally, in some interferometric modulator display applications, the drawings may not reflect an accurate scale, for example, the horizontal distance between mechanical layers of adjacent devices may be about 3-10 μm and the mechanical layers may each be about 30-50 μm long in the horizontal direction. As another example, the distance between pixels or mechanical layers in adjacent devices can be about 100 μm in certain radio frequency MEMS applications (e.g., switches, switched capacitors, varactors, resonators, etc.) while each mechanical layer can be about 30-50 μm long.

In the illustrated interferometric modulator (IMOD) implementation in FIG. 9A, a stationary lower electrode 116 can include an optical stack over a substrate 20. The optical stack may be analogous, for example, to the optical stack 16 described in reference to FIGS. 6A-6E. The substrate 20 provides means for supporting the electromechanical systems device. The substrate 20 can include a variety of materials, including glass or a transparent polymeric material which permits images to be viewed through the substrate 20. In some implementations, the substrate 20 can be substantially transparent to light, but the substrate 20 does not need to be 100% transparent to all wavelengths of light. The substrate 20 can be subjected to one or more prior preparation processes such as, for example, a cleaning process to facilitate efficient formation of the optical stack. Additionally, one or more layers can be provided on the substrate before providing the optical stack for the stationary lower electrode 116, such as optical buffer layers, electrical bussing signal layers and/or black mask layers to darken areas between pixels.

As described above with reference to FIG. 1, the lower electrode 116 can include a plurality of layers. For example, the optical stack for the IMOD lower electrode 116 can include an optional transparent conductor, such as indium tin oxide (ITO), a partially reflective optical absorber layer, such as chromium, and a transparent dielectric. In one implementation, the optical stack includes a molybdenum-chromium (MoCr) layer having a thickness in the range of about 30-80 Å, a AlOₓ layer having a thickness in the range of about 50-150 Å, and a SiO₂ layer having of thickness in the range of about 250-500 Å. The separate transparent conductor can be omitted in favor of employing a black mask structure, such as the black mask 23 of FIG. 6D, that includes a conductive layer to bus signals among pixels of the array, such that the thin, semitransparent absorber layer serves to provide conductivity sufficient for the optical stack to serve as the stationary electrode for the electrostatic operation of the electromechanical systems device. The optical stack can thus be electrically conductive, partially transparent and partially reflective. The absorber layer can be formed from a variety of materials that are partially reflective, such as various metals, semiconductors, and dielectrics, but is conductive for the illustrated implementation. In some implementations, some or all of the layers of the lower electrode 116, including, for example, the absorber layer, are patterned into parallel strips, and may form row electrodes in a display device as described above with reference to FIG. 1.

The stationary lower electrode 116 can be formed using a variety of methods, including deposition and patterning techniques. As used herein, and as will be understood by one having skill in the art, the term “patterned” refers to masking as well as etching processes. In some implementations, the stationary lower electrode 116 includes insulating or dielectric layer(s) covering conductive layer(s).

FIG. 9B illustrates providing and patterning a first sacrificial layer 170 over the substrate 20 and the stationary lower electrode 116. The first sacrificial layer 170 is a temporary layer, and at least a portion of the first sacrificial layer 170 is removed later during processing. For example, the first sacrificial layer 170 can later be removed to form a gap between a mechanical layer and the stationary lower electrode 116. The first sacrificial layer 170 can be selected to include more than one layer, or include a layer of varying thickness, to aid in the formation of a display device having a multitude of resonant optical gaps. For example, in a color interferometric modulator (IMOD) array, multiple IMODs are provided with, e.g., three different gap sizes, where each gap size represents a different reflected color. The formation of the first sacrificial layer 170 over the substrate 20 and the stationary lower electrode 116 can include deposition of a fluorine-etchable material such as molybdenum (Mo), tungsten (W) or amorphous silicon (Si), in a thickness selected to provide, after subsequent removal, a gap having the desired size. The thickness or vertical height of the first sacrificial layer 170 can be, for example, from less than about 0.2 μm for a green IMOD, about 0.2 μm to about 0.3 μm for a red IMOD, and about 0.3 μm for a blue IMOD. While gaps can have a wide variety of sizes for accomplishing their interferometric reflection function, in some implementations, thinner layers can facilitate later sealing of the release passage defined by the first sacrificial layer 170 which can prevent the need to clear away excessively thick sealing and encapsulating layers from peripheral contact pads. Deposition of the first sacrificial layer 170 over the stationary lower electrode 116 can be carried out using deposition techniques such as physical vapor deposition (PVD, e.g., sputtering), plasma-enhanced chemical vapor deposition (PECVD), thermal chemical vapor deposition (thermal CVD), or spin-coating.

FIG. 9C illustrates providing and patterning a post layer 171 over the substrate 20 and overlapping a portion of the first sacrificial layer 170. The post layer 171 can provide structural support for a mechanical layer and/or an encapsulation layer. The post layer 171 can include, for example, an inorganic and insulating material such as SiO₂ and/or SiON, and the post layer 171 can be patterned to form support structures. In one implementation, the thickness of the post layer 171 can be selected to be in the range of about 500-10,000 Å, for example, 1500 Å.

FIG. 9D illustrates providing a movable electrode 114 over the first sacrificial layer 170 and patterning the movable electrode 114. The movable electrode 114 is a movable means for defining a collapsible gap. The moveable electrode 114 may be analogous, for example, to any of the movable reflective layers 14 illustrated in FIGS. 6A-6E. The moveable electrode 114 may include a reflective sub-layer, a support layer, and/or a conductive layer, for example, as illustrated in the implementations shown in FIGS. 6D and 6E. The movable electrode 114 can be supported by the post layer 171 (supported sections not visible in the cross section of FIG. 9D) to keep at least a portion of the movable electrode 114 spaced from the stationary lower electrode 116 after the first sacrificial layer 170 is removed from under the movable electrode 114, for example, as shown by the post layer 18 in FIG. 6A. The movable electrode 114 can include more than one layer, such as a conductive layer, a support layer, and a moveable reflective layer. In some implementations, the support layer is a dielectric layer of, for example, SiON. The moveable reflective layer and the conductive layer can include, for example, metallic materials (e.g., Al₂O₃ or AlCu with about 0.5% Cu by weight). Conductors above and below the dielectric support layer can balance stresses and provide enhanced conduction. In some other implementations, the movable electrode 114 can include a single layer, such as the movable reflective layer 14 e.g., in FIG. 6A. The movable electrode 114 can be formed by a variety of techniques, such as atomic layer deposition (ALD). In some implementations, the thickness of the movable electrode 114 can be selected to be in the range of about 600-800 Å. Skilled artisans will appreciate that the movable electrode 114 can include a variety of layers, depending upon the electromechanical systems device functions. For example, the movable electrode 114 can be made flexible and conductive to function as the moveable electrode, e.g., in FIG. 6A, or to support a separate moveable electrode, e.g., in FIG. 6C.

FIG. 9E illustrates providing a second sacrificial layer 172 over the movable electrode 114, a portion of the post layer 171, and a portion of the first sacrificial layer 170. As illustrated in FIGS. 9E-9G, the first sacrificial layer 170 is wider than the second sacrificial layer 172 in a direction substantially parallel to the stationary lower electrode 116. Like the first sacrificial layer 170, the second sacrificial layer 172 is a temporary layer, and at least a portion of the second sacrificial layer 172 is removed later during processing. For example, the second sacrificial layer 172 can later be removed to form a gap between the movable electrode 114 and an encapsulation layer, as will be discussed below. The second sacrificial layer 172 can be selected to include more than one layer. The second sacrificial layer 172 can have a height of at least approximately 0.5 μm in the vertical direction, for example, 1 μm. In some implementations, the second sacrificial layer 172 can be about twice as thick as the first sacrificial layer 170. The second sacrificial layer 172 can be formed of the same materials and via similar processes as the first sacrificial layer 170. In some implementations, the first sacrificial layer 170 and the second sacrificial layer 172 can include substantially the same materials, or alternatively can be formed of different materials. While different sacrificial materials might entail a release process with two separate etch processes, preferably the materials are selected for selective removal together by the same etchant. The provision of the post layer 171 permits the use of one material for both sacrificial layers 170 and 172, while still protecting the first sacrificial layer 170 during patterning of the second sacrificial layer 172. In some implementations, a patterning etchant can select between the two materials while a later release etchant can remove both materials.

FIG. 9F illustrates providing an encapsulation layer 174, which can alternatively be referred to as a shell layer, over the second sacrificial layer 172 and the post layer 171. The shell layer can provide encapsulating means for encapsulating the movable electrode 114. One or more additional layer(s) can be formed between the second sacrificial layer 172 and the encapsulation layer 174. The encapsulation layer 174 can be formed of, for example, SiON, benzocyclobutene (BCB), acrylic, polyimide, silicon oxide, silicon nitride, AlOₓ, oxynitride, combinations thereof, and other similar encapsulating materials. The encapsulation layer 174 can be formed by a variety of techniques, such as PECVD. In some implementations, the thickness can be sufficient to protect the electromechanical device from moisture and other contaminants and to be stiff enough to remain spaced above the movable electrode 114 without interfering with operation after release, yet thin enough that clearing from peripheral contact pads is reasonably fast. For example, the thickness of the encapsulation layer 174 can be selected to be in the range of about 1000-50,000 Å, such as 20,000-30,000 Å.

After formation, the encapsulation layer 174 is typically non-planar. A planarization process can be performed on the encapsulation layer 174 in which the encapsulation layer 174 forms a substrate for fabrication or placement of electronic elements thereon. The planarization process may include a mechanical polishing (MP) process, a chemical mechanical planarization (CMP) process, and/or a spin-coating process.

The encapsulation layer 174 can be spaced apart from the relaxed state position of the movable electrode 114 by the second sacrificial layer 172. The introduction of a space, a cavity or a gap between the movable electrode 114 and the encapsulation layer 174 created by removing the second sacrificial layer 172 can improve mechanical strength of the MEMS device. When the encapsulation layer 174 and sealing layer 184 are subject to force loading caused by pressure differences between the inside and outside of the cavity or due to external forces such as finger touching, the encapsulation layer(s) 174 can deflect toward the movable electrode 114. Maintaining a space above the movable electrode 114 prevents the movable electrode 114 from touching the encapsulation layer 174. Without sufficient space, the movable electrode 114, or deformable layer, might risk collision with the encapsulating layer 174, potentially damaging the structure and shortening the life of the device.

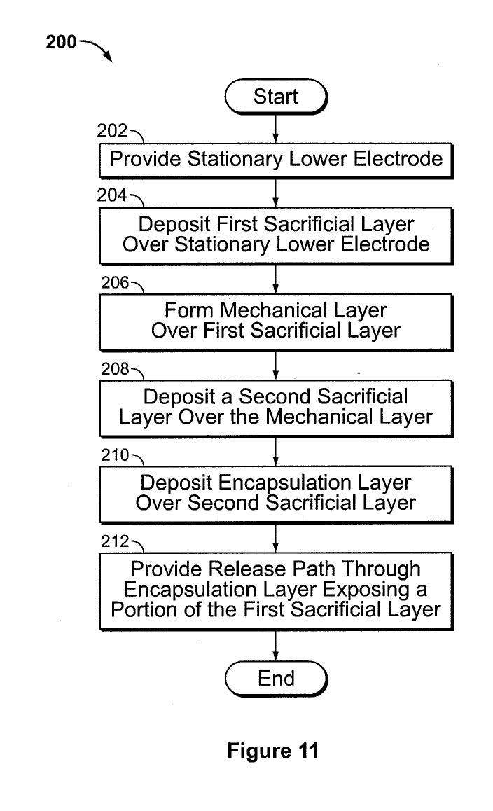

FIG. 9G illustrates providing a release hole 176 through the encapsulation layer 174 to expose the first sacrificial layer 170 without directly exposing the thicker second sacrificial layer 172. The release hole 176 can be formed by etching through the encapsulation layer 174. The release hole 176 can be included in a release path, which allows the first sacrificial layer 170 and the second sacrificial layer 172 to be etched, thereby releasing the movable electrode 114. The release path is an access means for release etching through the encapsulation layer 174 to remove the sacrificial material 170, 172 around the movable electrode 114. The release path can expose a portion of the first sacrificial layer 170 that extends beyond the second sacrificial layer 172 in a horizontal direction. The first sacrificial layer 170 can extend, for example, about 1-20 μm beyond the movable electrode 114 in the horizontal direction to allow for release etchant access. The release hole 176 also can be etched through the post layer 171. In this implementation, the post layer 171 can enclose substantially an entire horizontal perimeter of the release hole 176. In some implementations, the release hole 176 can be circular or annular, as shown in FIG. 11, however, other geometric orientations are also possible. The release hole 176 can have a width or diameter of, for example, about 2-10 μm.

FIG. 9H illustrates a partially formed electromechanical systems device in which the first sacrificial layer 170 and the second sacrificial layer 172 have been etched through the release path. In forming the structure shown in FIG. 9H, first, a portion of the first sacrificial layer 170 can be etched away. Removing a portion of the first sacrificial layer 170 between the substrate 20 and the post layer 171 and/or the encapsulation layer 174 that extends beyond the second sacrificial layer 172 creates a release passage 178. In creating the release passage 178, a portion of the first sacrificial layer 170 can be etched before removing any of the second sacrificial layer(s) 172. The remaining portions of the first sacrificial layer 170 and the entire second sacrificial layer 172 can be reached by an etchant through the release passage 178 which has an opening 180 to the release hole 176. As shown in FIGS. 9H-9J, the release passage 178 is positioned between the post layer 171 and the substrate 20.

After the first sacrificial layer 170 has been removed, the movable electrode 114 is spaced from the substrate 20 by a gap 182. The movable electrode 114 can be supported by the post layer 171 (supporting sections of which not visible in the cross section of FIGS. 9H-9J), such that the gap 182 is maintained from the substrate 20. The gap 182 roughly corresponds to the thickness of the removed first sacrificial layer 170, although a “launch effect” from internal tension and interaction with support structures can cause a slight upward, or downward, deviation. The gap 182 is collapsible, for example, as described above and shown in FIG. 1. The vertical height of the gap 182 can be from about 0.2 μm to about 0.3 μm, however, the gap 182 can be different heights in different MEMS devices. For example, in a color interferometric display system, multiple different devices may have different gap sizes to interferometrically enhance, for example, red, green, and blue, such that the gap 182 represents an interferometric optical cavity. Similarly, three different mechanical layer materials or thicknesses (affecting stiffness) can be employed to allow use of the same actuation voltage for collapsing the movable electrode 114 in three different gap sizes.

Although gap sizes can vary from device to device, the release passage 178 can have substantially the same vertical height and/or vertical position as the gap 182 that separates the movable electrode 114 from the substrate 20 for each device, as shown in FIG. 9H. This results from using the first sacrificial layer 170 to space both the movable electrode 114 and a ceiling of the release passage 178 from the substrate 20. In some implementations, using the first sacrificial layer 170 to create both the gap 182 and the release passage 178 can efficiently save additional masks and patterning processing.

Dimensions of the release passage 178 are chosen to facilitate subsequent sealing by a conformal deposition. The release passage 178 can be long and narrow. For example, the release passage 178 can have a horizontal length substantially parallel to a major surface of the substrate 20 that is greater than and typically around 2-20 times the vertical height of the release passage 178 and the gap 182. In some implementations, the horizontal length of the release passage 178 substantially parallel to a major surface of the substrate 20 is approximately at least five times the vertical height of the gap 182. Such length reduces risk that deposition of the subsequent sealing layer will reach and interfere with the movable electrode 114.

In some implementations, the release holes 176 can be used to create a desired environment for the MEMS element. For example, a substantial vacuum or low pressure environment can be established through the release holes 176. FIG. 9I shows a MEMS device in which the release holes 176 through the encapsulation layer 174 have been plugged with a sealing layer 184. The sealing layer 184 is a sealing means for sealing the release path. In some implementations, the encapsulation layer 174 with plugged release holes 176 forms a hermetic seal for the MEMS element.

FIG. 9I illustrates providing and patterning the sealing layer 184. After the first sacrificial layer 170 and the second sacrificial layer 172 are etched away, the release hole 176 can be plugged with the sealing layer 184, thereby sealing the electromechanical device. A portion of the sealing layer 184 can seal the release hole 176 by blocking the opening 180 of the release passage 178 within the release hole 176. After depositing the sealing layer 184, the release passage 178 is adjacent to a portion of the sealing layer 184 at the same vertical position as a portion of the gap 182. As shown in FIGS. 9I and 9J, the sealing layer 184 is thicker than the vertical height of the release passage 178, which can ensure effective sealing.

The sealing layer 184 also can be a conformal layer or a thin film. The sealing layer 184 can be formed by, for example, PVD, spin-on glass (SOG), ALD, PECVD and/or thermal CVD processes. The sealing layer 184 can be formed of a dielectric material, for example, SiON.

FIG. 9J shows an electromechanical systems device with a contact via 186 etched through the sealing layer 184, the encapsulation layer 174, and the post layer 171. While the contact via 186 is illustrated as landing on a portion of the stationary electrode 116, the skilled artisan will appreciate that more typically the contact pads are formed of different interconnect materials in peripheral regions outside of the array of electromechanical systems devices, for mounting driver chips or otherwise interfacing with other electronic components.

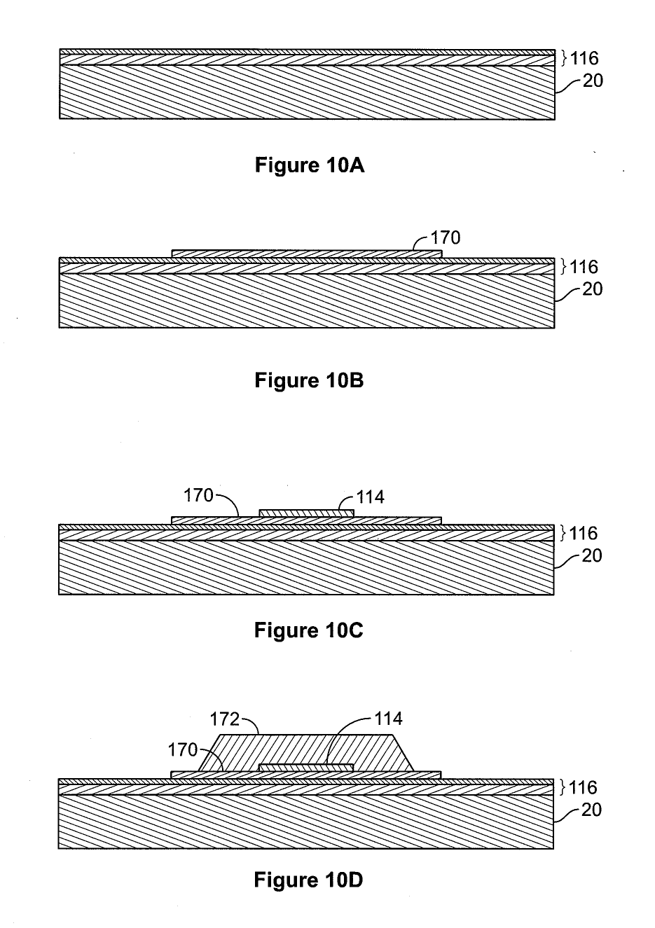

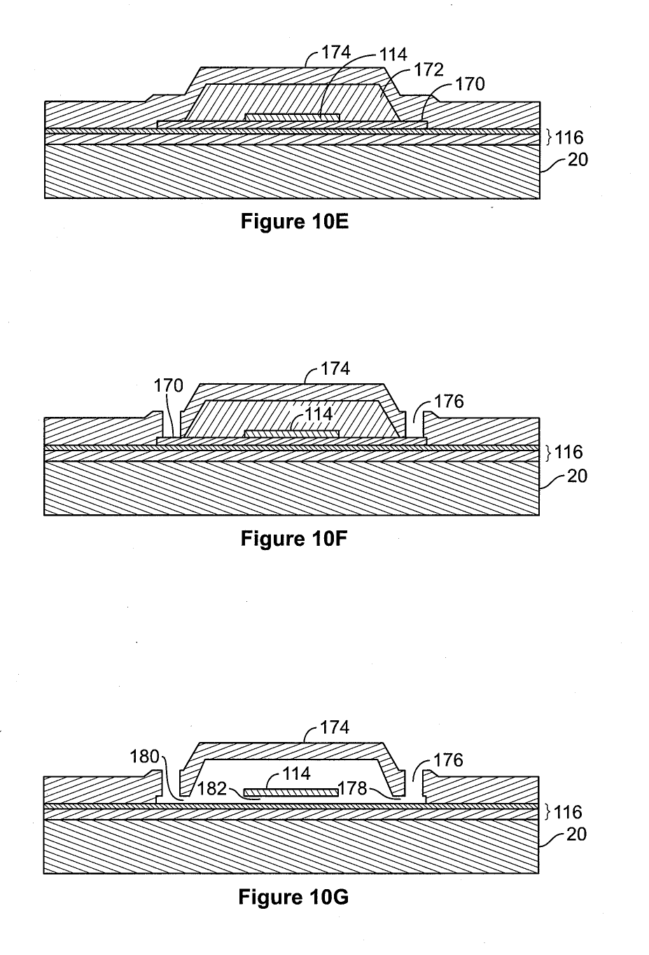

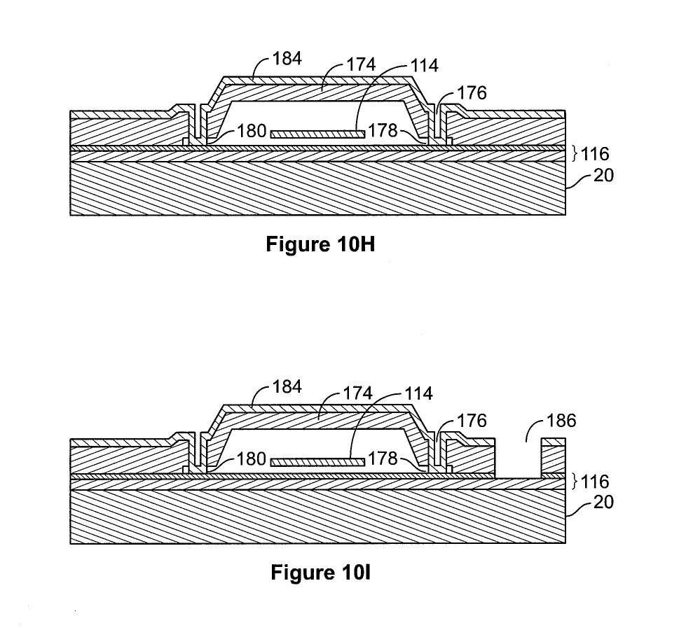

FIGS. 10A through 10I show examples of schematic cross-sections illustrating manufacturing processes for encapsulated electromechanical devices according to another implementation. The process illustrated in FIGS. 10A-10I is similar to the process illustrated in FIGS. 9A-9J and like numbers indicate similar parts. However, the post/support layer 171 shown in FIGS. 9A-9J is not included between portions of an encapsulation layer 174 and a substrate 20. Instead, the encapsulation layer 174 can be formed over the substrate 20 and the movable electrode 114 without a post layer 171 providing structural support for the encapsulation layer 174. In one implementation, as shown in FIG. 10E, the encapsulation layer 174 can be formed directly over a portion of the optical stack 16, a portion of the first sacrificial layer 170 extending beyond the second sacrificial layer 172, and the second sacrificial layer 172. As shown in FIG. 10F, the release hole 176 can extend through the encapsulation layer 174 to expose a portion of the first sacrificial layer 170 that extends beyond the second sacrificial layer 172 in a direction substantially horizontal to a major surface of the substrate 20. As illustrated in FIGS. 10G-10I, the encapsulation layer 174 is spaced above the substrate 20 at the opening 180 to the release hole 176 at substantially the same vertical height and/or vertical position as the movable electrode 114. A post layer (not shown) can still be employed, but is patterned to not intervene between the encapsulation layer 174 and the substrate 20 around the release holes 176. The post layer supports the mechanical layer at locations other than those visible in the cross section of FIG. 10H-10J, such that the movable electrode 114 is spaced apart from the substrate 20. In addition, the encapsulation layer 174 defines the ceiling of the release passage 178, as also shown in FIGS. 10G-10I.

For the implementations illustrated in FIGS. 10D-10F, the second sacrificial layer 172 directly overlies the first sacrificial layer 170 at the outer periphery of the second sacrificial layer 172. Accordingly, in order to prevent damage to the first sacrificial layer 170 during patterning of the second sacrificial layer 172, the second sacrificial layer 172 should be selectively etchable relative to the first sacrificial layer 170. For example, they may be different materials and either a selective etch chemistry is available for the patterning and a non-selective (between the two materials) etch chemistry is available for the release etch, or two different selective etches can be used during the release etch. Of course all of these etches should select against the material of any exposed movable electrode 114, post material and stationary electrode 116. As an alternative to using two different sacrificial materials, etch stop layers can be employed between the sacrificial layers 170, 172 in a manner known in the art.

FIG. 11 shows an example of a flow diagram illustrating a process of forming an encapsulated electromechanical systems device. The electromechanical systems device can be an interferometric modulator. The process 200 can include any combination of features described in reference to FIGS. 9A-9J and 10A-10I.

In the illustrated process 200, a stationary lower electrode is provided at block 202. A first sacrificial layer is deposited over the stationary lower electrode at block 204. Then, at block 206, a mechanical layer is formed over the stationary lower electrode. The first sacrificial layer defines a separation gap between the stationary lower electrode and the mechanical layer. A second sacrificial layer is deposited over the mechanical layer at block 208. In some implementations, the first sacrificial layer is wider than the second sacrificial layer in a direction substantially parallel to the stationary lower electrode. An encapsulation layer is formed over the second sacrificial layer at block 210. Then a release path including a release hole through the encapsulation layer is provided at block 212. The release path exposes a portion of the first sacrificial layer. This can allow the first and second sacrificial layers to be etched through the release hole.

In some implementations, the process 200 also can include etching at least a portion of the first sacrificial layer before etching any of the second sacrificial layer(s). Alternatively or additionally, the release path can be extended by removing at least a portion of the first sacrificial layer between the substrate and the encapsulation layer.

According to some implementations, the process also can include forming a support layer, such as a post, over the stationary lower electrode and over at least a portion of the first sacrificial layer. In such implementations, the release path can include extending a release hole through the support layer. At least a portion of the first sacrificial layer can be removed before removing any of the second sacrificial layer, thereby creating a release passage between the support layer and the substrate.

Electromechanical systems devices formed by the processes illustrated in FIGS. 9A-9J, 10A-10I, and 11 can have desirable operating characteristics. A dry environment within a thin-film encapsulation can result in low offset voltages during a charging test. For example, an offset shift of below 0.2-volts after a 20-volts charging test has been observed in devices of one arrangement for the implementation illustrated in FIG. 9, in contrast to severe charging or large offset shift in un-encapsulated devices.

Moreover, MEMS devices formed by the processes illustrated in FIGS. 9A-9J, 10A-10I, and 11 demonstrate enhanced seal integrity. About a 0.2-volts charging offset shift during an >1000 hr 85° C./85% R.H. seal integrity test conducted on devices of one arrangement for the implementation illustrated in FIG. 9 indicates almost no moisture permeation.

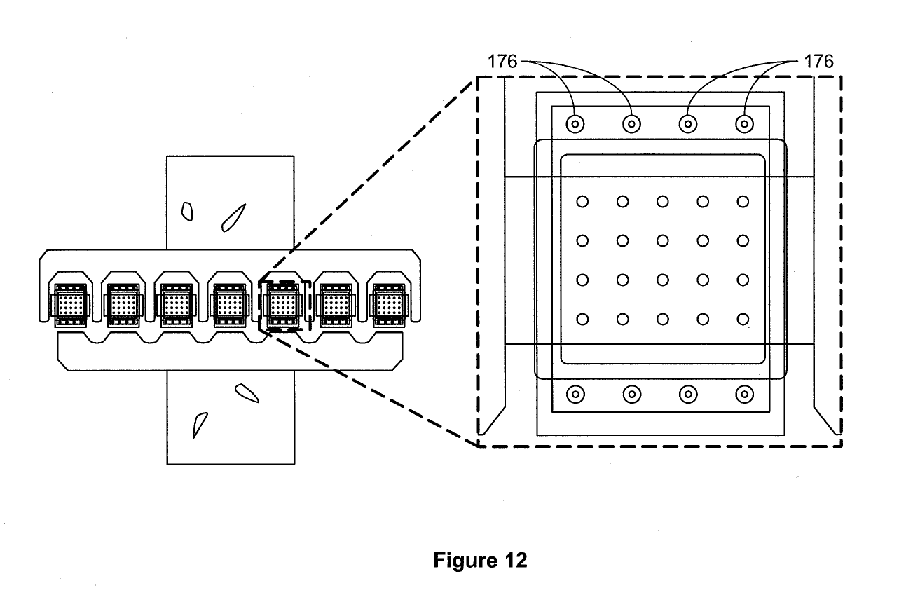

FIG. 12 illustrates an example top view of release holes in an interferometric modulator (IMOD) array showing a 7×1 IMOD array. This is a microscopic view of a functional IMOD array. Each element of the IMOD array includes an electromechanical systems device that represents a pixel. As shown in the enlarged view of one IMOD, each release hole 176 can be substantially circular when viewed from above. In addition, multiple release holes 176 can be included per IMOD.

Although the implementations described are often illustrated in the context of interferometric modulator devices, skilled artisans will recognize that the teachings herein are applicable to a wide variety of electromechanical systems devices, for example, radio frequency MEMS devices and/or analog IMOD display devices.

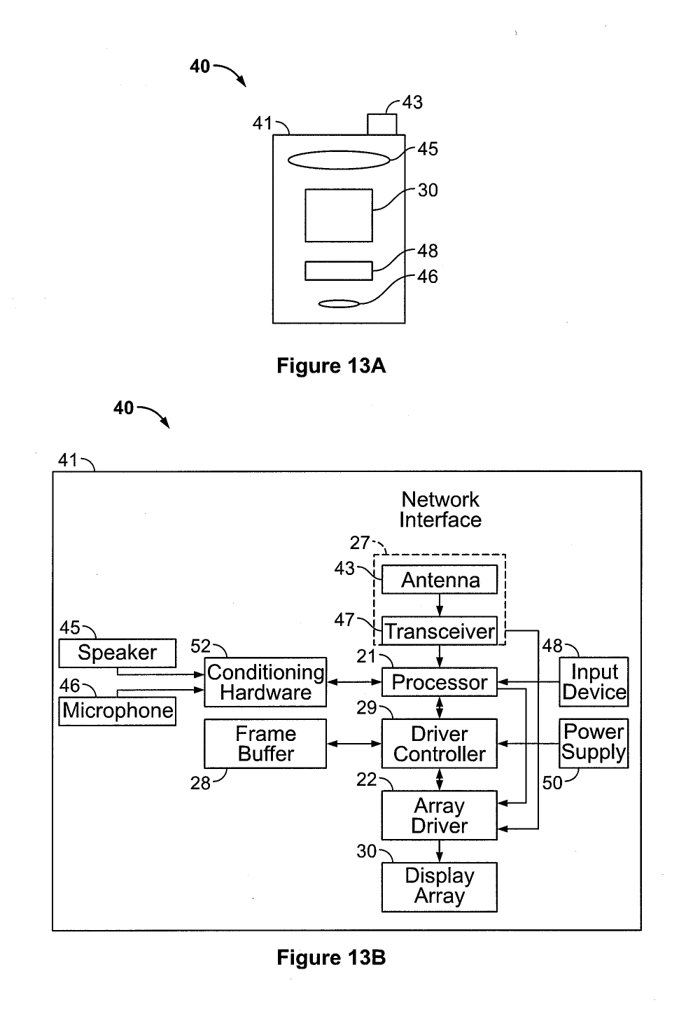

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising an electromechanical systems device, the electromechanical systems device comprising:
a substrate;
a mechanical layer spaced from the substrate by a gap;
a shell layer encapsulating the mechanical layer, the shell layer including a release hole therethrough;
a release passage having substantially the same vertical height as the gap, the release passage having an opening at the release hole; and
a conformal layer sealing the release hole in the shell layer, at least a portion of the conformal sealing layer blocking the opening of the release passage within the release hole.

2. The apparatus of claim 1, wherein the release passage has a horizontal length that is at least five times the vertical height of the gap, the horizontal length substantially parallel to a major surface of the substrate.

3. The apparatus of claim 1, wherein the conformal sealing layer is thicker than the vertical height of the release passage.

4. The apparatus of claim 1, wherein the shell layer defines a ceiling of the release passage.

5. The apparatus of claim 1, wherein the electromechanical systems device comprises an interferometric modulator.

6. The apparatus of claim 1, further comprising:
a display;
a processor that is configured to communicate with the display, the processor being configured to process image data; and
a memory device that is configured to communicate with the processor.

7. The apparatus as recited in claim 6, further comprising:
a driver circuit configured to send at least one signal to the display.

8. The apparatus as recited in claim 7, further comprising:
a controller configured to send at least a portion of the image data to the driver circuit.

9. The apparatus as recited in claim 6, further comprising:
an image source module configured to send the image data to the processor.

10. The apparatus as recited in claim 9, wherein the image source module comprises at least one of a receiver, transceiver and transmitter.

11. The apparatus as recited in claim 6, further comprising:
an input device configured to receive input data and to communicate the input data to the processor.

12. An apparatus comprising an electromechanical systems device, the electromechanical systems device comprising:
a substrate;
a post layer providing structural support formed over the substrate;
a mechanical layer spaced from the substrate by a gap;
a shell layer encapsulating the mechanical layer; and
a sealing layer over the shell layer, the sealing layer formed within a release hole etched though the shell layer and the post layer.

13. The apparatus of claim 12, wherein the electromechanical systems device further comprises a release passage adjacent to at least a portion of the sealing layer at the same vertical position as at least a portion of the gap.

14. The apparatus of claim 13, wherein the release passage is between the post layer and the substrate.

15. The apparatus of claim 13, wherein at least a portion of the sealing layer blocks an opening between the release passage and the release hole.

16. The apparatus of claim 12, wherein the post layer encloses substantially an entire horizontal perimeter of the release hole.

17. The apparatus of claim 12, wherein, horizontally adjacent to at least a portion of the sealing layer, the post layer is spaced from the substrate at substantially the same vertical height as the gap.

18. An apparatus comprising an electromechanical systems device, the electromechanical systems device comprising:
means for supporting the electromechanical device;
movable means for defining a collapsible gap;
encapsulating means for encapsulating the movable means;
access means for release etching through the encapsulating means at least a portion of sacrificial material below the movable means prior to release etching sacrificial material above the movable means; and
sealing means for sealing the access means.

19. The apparatus of claim 18, wherein the electromechanical systems device comprises an interferometric modulator.

20. The apparatus of claim 18, wherein the access means comprises a release hole through the encapsulating means and a release passage having substantially the same vertical height and vertical position as the collapsible gap.

21. The apparatus of claim 20, wherein the sealing means comprises a conformal layer that blocks an opening of the release passage within the release hole.

22. The apparatus of claim 18, wherein the movable means comprises a mechanical layer.

23. The apparatus of claim 18, wherein the means for supporting comprises a substantially transparent substrate.

24. The apparatus of claim 18, wherein the encapsulating means comprises a conformal shell layer spaced above the movable means.

25. A method of forming a electromechanical systems device, the method comprising:
providing a stationary lower electrode;
depositing a first sacrificial layer over the stationary lower electrode, the first sacrificial layer defining a separation gap between the stationary lower electrode and a mechanical layer;
forming the mechanical layer over the first sacrificial layer;
depositing a second sacrificial layer over the mechanical layer;
depositing an encapsulation layer over the second sacrificial layer; and
providing a release path including a release hole through the encapsulation layer, the release path exposing a portion of the first sacrificial layer.

26. The method of claim 25, wherein the release hole exposes a portion of the first sacrificial layer.

27. The method of claim 25, further comprising etching at least a portion of the first sacrificial layer before etching any of the second sacrificial layer.

28. The method of claim 25, wherein the first sacrificial layer is wider than the second sacrificial layer in a direction substantially parallel to the stationary lower electrode.

29. The method of claim 25, further comprising extending the release path by removing at least a portion of the first sacrificial layer between the substrate and the encapsulation layer.

30. The method of claim 25, further comprising forming a support layer over the stationary lower electrode and over at least a portion of the first sacrificial layer, wherein providing the release path comprises extending a release hole through the support layer.

31. The method of claim 30, further comprising removing at least a portion of the first sacrificial layer before removing any of the second sacrificial layer, thereby creating a release passage between the support layer and the substrate.

32. The method of claim 25, further comprising etching the first and second sacrificial layers through the release hole.

33. The method of claim 25, wherein the stationary lower electrode comprises an optical stack.

34. The method of claim 25, wherein the electromechanical systems device is an interferometric modulator.
